(19) United States
(12) Patent Application Publication
(10) Pub. No.: US 2026/0217088 A1
(43) Pub. Date: Jul. 30, 2026

(54) POSITIVE PRESSURIZATION SYSTEMS FOR PREVENTING ENVIRONMENTAL ELEMENTS FROM ENTERING MOTOR VEHICLE CARGO SPACES

(71) Applicant: FORD GLOBAL TECHNOLOGIES, LLC, Dearborn, MI (US)

(72) Inventors: Thomas Anthony Vassa, Sparks, NV (US); Andrew Brown, Royal Oak, MI (US); James Ethan Jones, Westland, MI (US); Brendan Diamond, Naples, FL (US)

(21) Appl. No.: 19/036,707

(22) Filed: Jan. 24, 2025

(51) Int. Cl. B60H 1/24

(52) U.S. Cl. CPC B60H 1/24

(57) ABSTRACT

Positive pressurization systems are provided for motor vehicles. The positive pressurization systems may direct a supply of filtered airflow into an enclosed vehicle cargo space in order to substantially prevent environmental elements (e.g., dust, dirt, debris, rain, snow, etc.) from entering the cargo space. An exemplary positive pressurization system may include a pressurization device mounted within a bedside cavity of a cargo bed and that is controllable based on sensor feedback from a vehicle sensor system. The pressurization device may also be manually controlled.

### TECHNICAL FIELD

This disclosure relates generally to motor vehicles, and more particularly to positive pressurization systems that are capable of substantially preventing environmental elements from entering into motor vehicle cargo spaces.

### BACKGROUND

Motor vehicles typically include one or more cargo spaces for storing/hauling various types of cargo. For example, a pickup truck includes a cargo bed for storing/hauling cargo at the rear of the truck. Some vehicle users may desire to protect the cargo space from environmental elements such as dirt, dust, debris, water, snow, etc.

### SUMMARY

A motor vehicle according to an exemplary aspect of the present disclosure includes, among other things, an enclosed cargo space, and a pressurization device including a blower motor assembly operable to direct an airflow into the enclosed cargo space for pressurizing the enclosed cargo space.

In a further non-limiting embodiment of the foregoing motor vehicle, the enclosed cargo space is established by a cargo bed and a cover that is securable to the cargo bed.

In a further non-limiting embodiment of either of the foregoing motor vehicles, the pressurization device is mounted within a bedside cavity of a side wall of the cargo bed.

In a further non-limiting embodiment of any of the foregoing motor vehicles, the bedside cavity extends between an inner panel and an outer panel of the side wall.

In a further non-limiting embodiment of any of the foregoing motor vehicles, an outlet port of the pressurization device is positioned within the inner panel for directing the airflow into the enclosed cargo space.

In a further non-limiting embodiment of any of the foregoing motor vehicles, the pressurization device is mounted at a location between a wheel well and a front wall of the cargo bed.

In a further non-limiting embodiment of any of the foregoing motor vehicles, the blower motor assembly is housed within a first portion of a housing of the pressurization device, an intake duct extends in a first direction from the first portion of the housing, and an exhaust duct extends in a second direction from the first portion of the housing.

In a further non-limiting embodiment of any of the foregoing motor vehicles, an inlet port of the pressurization device is connected to the intake duct, and an outlet port of the pressurization device is connected to the exhaust duct.

In a further non-limiting embodiment of any of the foregoing motor vehicles, the pressurization device includes an air filter that is positioned within the intake duct.

In a further non-limiting embodiment of any of the foregoing motor vehicles, the blower motor assembly is operable to pull an intake air from atmosphere through the air filter prior to directing the airflow into the enclosed cargo space.

In a further non-limiting embodiment of any of the foregoing motor vehicles, a sensor system is configured to sense a condition internal or external to the enclosed cargo space.

In a further non-limiting embodiment of any of the foregoing motor vehicles, a controller is programmed to command activation or deactivation of the blower motor assembly based on sensor data received from the sensor system.

A positive pressurization system for a motor vehicle according to another exemplary aspect of the present disclosure includes, among other things, a pressurization device including a blower motor assembly, a sensor system operable to sense a condition in or around the motor vehicle, and a controller programmed to command activation or deactivation of the blower motor assembly based on sensor data received from the sensor system.

In a further non-limiting embodiment of the foregoing positive pressurization system, the blower motor assembly is operable to provide an airflow for pressurizing an enclosed cargo space of the motor vehicle when activated.

In a further non-limiting embodiment of either of the foregoing positive pressurization systems, the controller is programmed to activate the blower motor assembly when the sensor data indicates that the motor vehicle is traveling on a dirt road or a gravel road.

In a further non-limiting embodiment of any of the foregoing positive pressurization systems, the controller is programmed to activate the blower motor assembly when the sensor data indicates a presence of dust particles within an enclosed cargo space of the motor vehicle.

In a further non-limiting embodiment of any of the foregoing positive pressurization systems, the controller is programmed to activate the blower motor assembly when the sensor data indicates a presence of rain or snow.

In a further non-limiting embodiment of any of the foregoing positive pressurization systems, the controller is programmed to activate the blower motor assembly when the sensor data indicates a presence of carbon monoxide.

In a further non-limiting embodiment of any of the foregoing positive pressurization systems, the controller is programmed to activate the blower motor assembly when a wheel speed threshold has been exceeded.

In a further non-limiting embodiment of any of the foregoing positive pressurization systems, the controller is programmed to activate the blower motor assembly when the motor vehicle enters a geofenced area.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a motor vehicle equipped with a positive pressurization system.

FIG. 2 is a rear perspective view of select portions of the motor vehicle of FIG. 1.

FIG. 3 illustrates select portions of a cargo space of the motor vehicle shown in FIGS. 1 and 2.

FIG. 4 is a partial view of an underside of the cargo space shown in FIGS. 2-3.

FIG. 5 illustrates an exemplary pressurization device of a positive pressurization system for a motor vehicle.

FIG. 6 is an exploded view of the pressurization device of FIG. 5.

FIG. 7 schematically illustrates an exemplary operating mode for cleaning an air filter of the pressurization device of FIGS. 5-6.

FIG. 8 illustrates aspects of an automated positive pressurization system for a motor vehicle.

FIG. 9 illustrates aspects of a manually controllable positive pressurization system for a motor vehicle.

### DETAILED DESCRIPTION

This disclosure describes positive pressurization systems for motor vehicles. The positive pressurization systems may direct a supply of filtered airflow into an enclosed vehicle cargo space in order to substantially prevent environmental elements (e.g., dust, dirt, debris, rain, snow, etc.) from entering the cargo space. An exemplary positive pressurization system may include a pressurization device mounted within a bedside cavity of a cargo bed and that is controllable based on sensor feedback from a vehicle sensor system. The pressurization device may also be manually controlled. These and other features of this disclosure are discussed in greater detail in the following paragraphs of this detailed description.

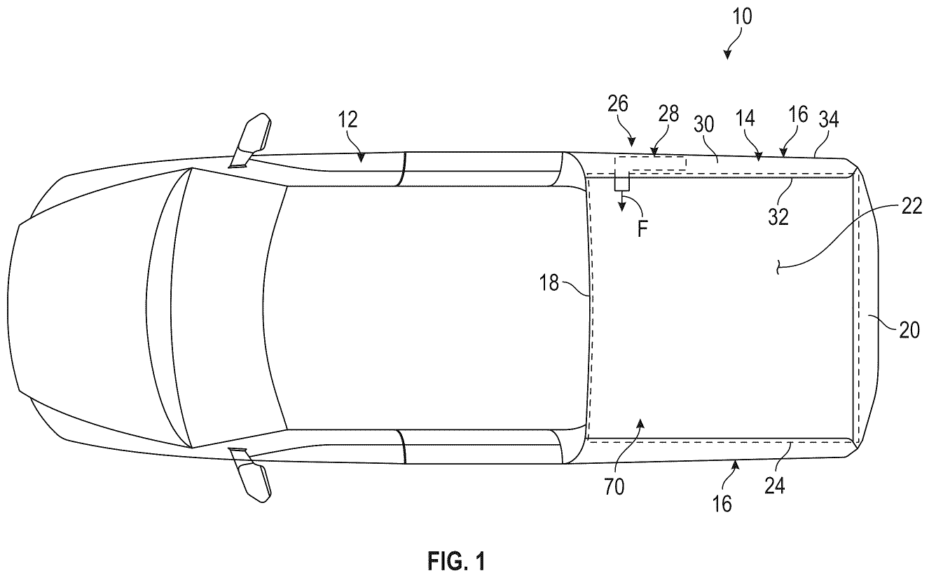

FIGS. 1-4 schematically illustrate a motor vehicle 10 that includes a passenger cabin 12 and a cargo bed 14 located rearward of the passenger cabin 12. The vehicle 10 could be a conventional, internal combustion engine powered vehicle, a hybrid or plug-in hybrid vehicle, a battery electric vehicle, an autonomous vehicle (i.e., a driverless vehicle), etc.

Although a specific component relationship is illustrated in the figures of this disclosure, the illustrations are not intended to limit this disclosure. The placement and orientation of the various components of the depicted vehicles are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the vehicle 10 is a pickup truck, and therefore the cargo bed 14 establishes a rear cargo space for storing and/or hauling cargo on the pickup truck. The cargo bed 14 may generally be defined by side walls 16, a front wall 18 that is adjacent to the passenger cabin 12, a tailgate 20 that acts as a rear wall of the cargo bed 14 when closed, and a floor 22 that acts as a base of the cargo bed 14.

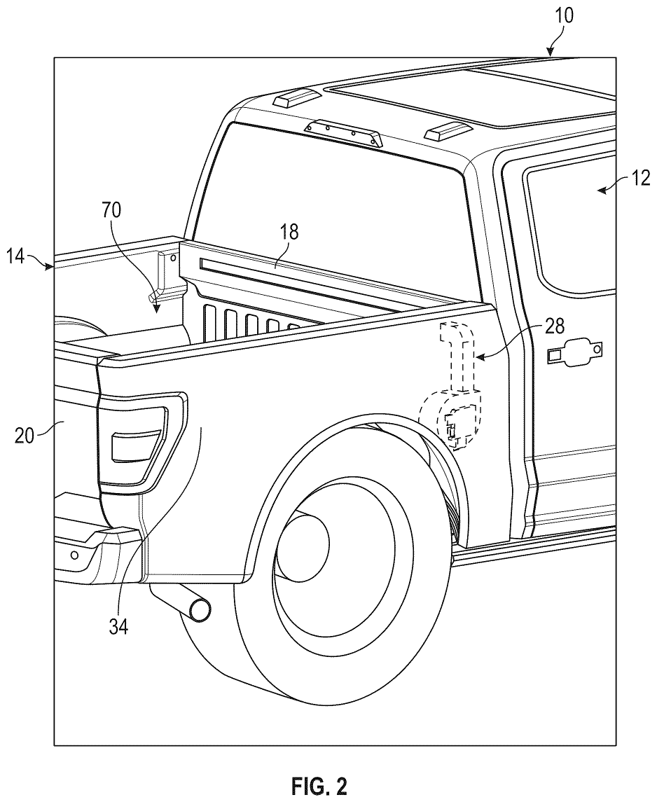

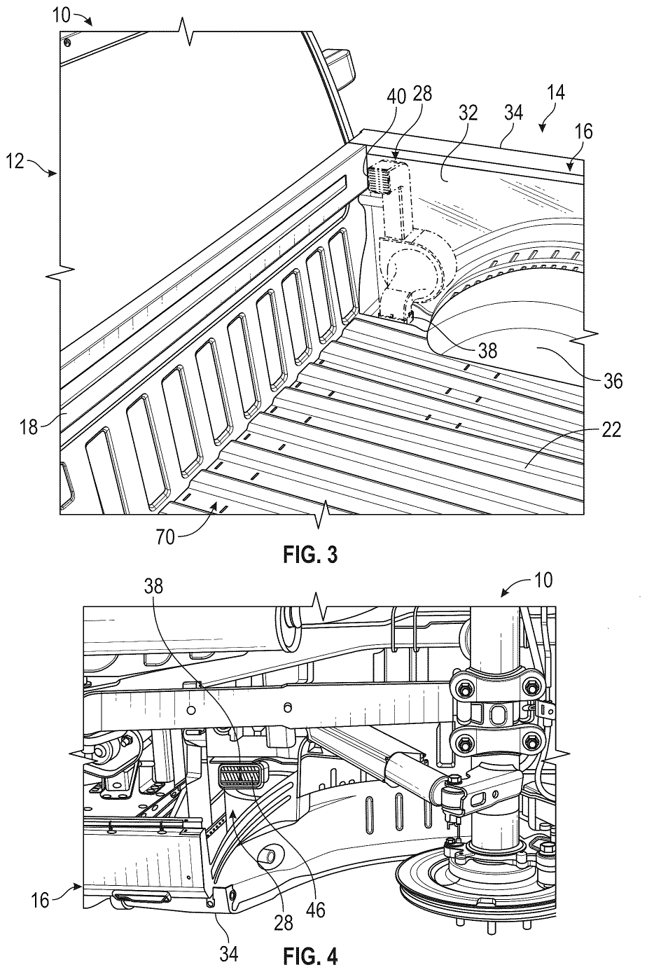

A cover 24 (shown schematically in FIG. 1 using dashed lines and intentionally omitted in FIGS. 2-3 for clarity) may be positioned for closing off a top side of the cargo bed 14 (e.g., the side opposite from the floor 22, which would otherwise be open to the exterior environment). The cover 24 may span laterally between the side walls 16 and longitudinally between the front wall 18 and the tailgate 20. The cover 24 and the cargo bed 14 may therefore cooperate to establish an enclosed cargo space 70 of the vehicle 10. The cover 24 may be a tonneau cover, a bed cap/topper, or any other type of cover.

Due at least in part to vehicle aerodynamics and the fact that the various seams between the side walls 16/front wall 18/tailgate 20/floor 22/cover 24 are typically not perfectly sealed, environmental elements such as dust, dirt, debris, rain, snow, etc. can still be drawn into the enclosed cargo space 70 even when the cargo bed 14 is covered by the cover 24. This can be dissatisfying to the vehicle owner when hauling important/sensitive cargo within the cargo bed 14. The vehicle 10 may therefore be equipped with a positive pressurization system 26 that is designed to pressurize the enclosed cargo space 70 (e.g., by forcing air to flow through any air leakage paths), thereby substantially preventing environmental elements from entering the enclosed cargo space 70.

The positive pressurization system 26 may include one or more pressurization devices 28 that can be arranged for directing an airflow F into the enclosed cargo space 70 in order to pressurize it. As further discussed below, each pressurization device 28 of the positive pressurization system 26 may be configured to pull ambient air from an exterior environment surrounding the vehicle 10, filter the ambient air, and then direct the filtered air as the airflow F into the enclosed cargo space 70 for minimizing the ability of environmental elements from entering therein.

In an embodiment, the pressurization device 28 may be mounted in a bedside cavity 30 that is located within one of the side walls 16 of the cargo bed 14 of the vehicle 10. The bedside cavity 30 may extend between an inner panel 32 and an outer panel 34 of the side wall 16 at a location between a wheel well 36 and the front wall 18 of the cargo bed 14. However, other mounting locations for the pressurization device 28 may also be suitable within the scope of this disclosure.

A portion of the pressurization device 28 may extend vertically below the floor 22 of the cargo bed 14. Vertical and horizontal, for purposes of this disclosure, are with reference to ground in an ordinary orientation of the vehicle 10 during operation. An inlet port 38 (best shown in FIG. 4) of the pressurization device 28 may therefore be accessible from an underside of the side wall 16 at a location that is below the floor 22. At this position, the inlet port 38 is easily assessible by a user, such as for servicing the pressurization device 28, for example.

An outlet port 40 (best shown in FIG. 3) of the pressurization device 28 may be mounted within the inner panel 32 of the side wall 16 at a location that is vertically above the floor 22. At this location, the outlet port 40 is appropriately positioned to direct the airflow F directly into the enclosed cargo space 70.

Notably, the specific mounting location of the pressurization device 28 described above and shown in FIGS. 1-4 is exemplary only and is not intended to limit this disclosure. Moreover, although pictured and described herein with respect to the cargo bed 14, the positive pressurization system 26 could be utilized for pressurizing other cargo spaces (e.g., a frunk, a gear tunnel or other enclosed vehicle storage compartment, etc.) of the vehicle 10. Accordingly, as would be appreciated by persons of ordinary skill in the art having the benefit of this disclosure, any enclosable vehicle cargo space could benefit from the teachings of this disclosure.

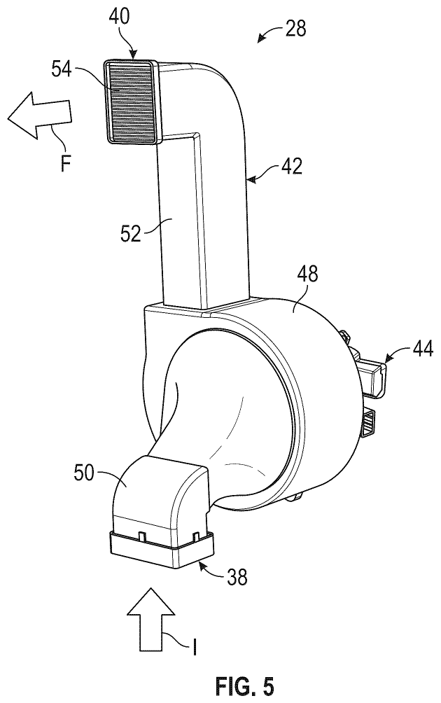

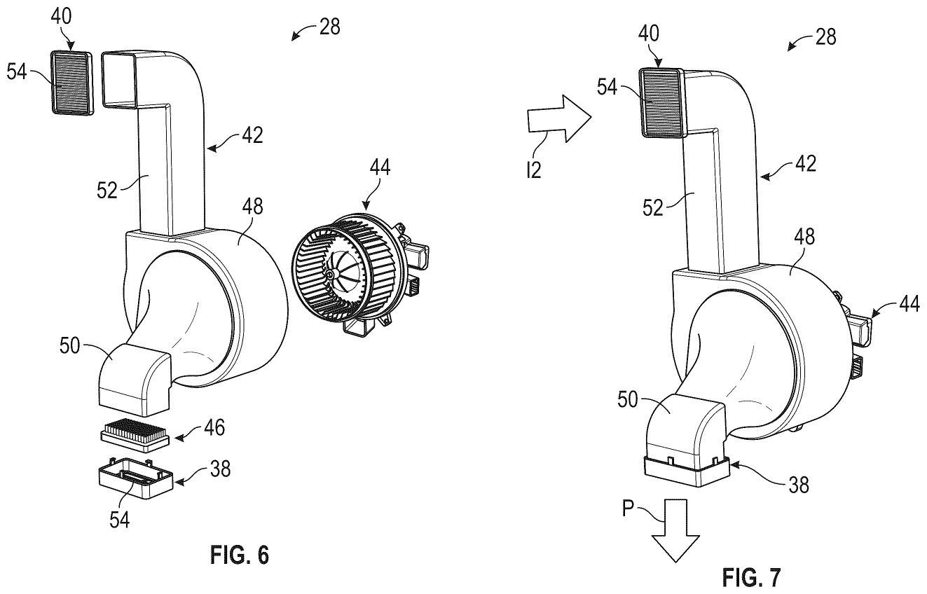

FIGS. 5, 6, and 7, with continued reference to FIGS. 1-4, illustrate additional details associated with the pressurization device 28 of the positive pressurization system 26. The pressurization device 28 may include a housing 42, a blower motor assembly 44, an air filter 46, the inlet port 38, and the outlet port 40.

The housing 42 may include a motor housing portion 48, an intake duct 50, and an exhaust duct 52. The motor housing portion 48, the intake duct 50, and the exhaust duct 52 may be formed together to provide a single-piece unitary structure of the housing 42.

The blower motor assembly 44 may be at least partially housed within the motor housing portion 48 and may be connected to a vehicle power source for operation. The intake duct 50 may extend in a first direction from the motor housing portion 48, and the exhaust duct 52 may extend in a second, opposite direction from the motor housing portion 48. The inlet port 38 may be secured to the intake duct 50, and the outlet port 40 may be secured to the exhaust duct 52. Each of the inlet port 38 and the outlet port 40 may include a grille portion 54 that can prevent debris from entering the pressurization device 28 while idle.

The air filter 46 may be positioned at or near an upstream end of the intake duct 50. The air filter 46 may be retained in place relative to the intake duct 50 by the inlet port 38. The inlet port 38 may be removed from the intake duct 50 for servicing the air filter 46.

During vehicle conditions in which it is desirable to pressurize the enclosed cargo space 70, intake air I may be pulled from atmosphere and may pass through the inlet port 38 and then through the air filter 46 for filtering. The blower motor assembly 44 may pressurize the air before it enters the exhaust duct 52. The air may then be directed through the outlet port 40 as the airflow F for pressurizing the enclosed cargo space 70 (see, e.g., schematic depiction of FIG. 5).

The pressurization device 28 may also be operated in reverse for cleaning the air filter 46. For example, as schematically shown in FIG. 7, intake air I2 may be pulled through the outlet port 40 from the enclosed cargo space 70. The intake air I2 may then be directed through the housing 42 of the pressurization device 28 before eventually passing through the air filter 46 as purge air P. The purge air P may clean the air filter 46 before being expelled to atmosphere through the inlet port 38. The blower motor assembly 44 is generally operated to spin in an opposite direction than that performed when pressurizing the enclosed cargo space 70 when performing such a filter “purge” methodology. In an embodiment, the filter purge/cleaning operating mode is performed automatically as part of a vehicle shutdown sequence to ensure the air filter 46 is maintained clean between filter replacement intervals.

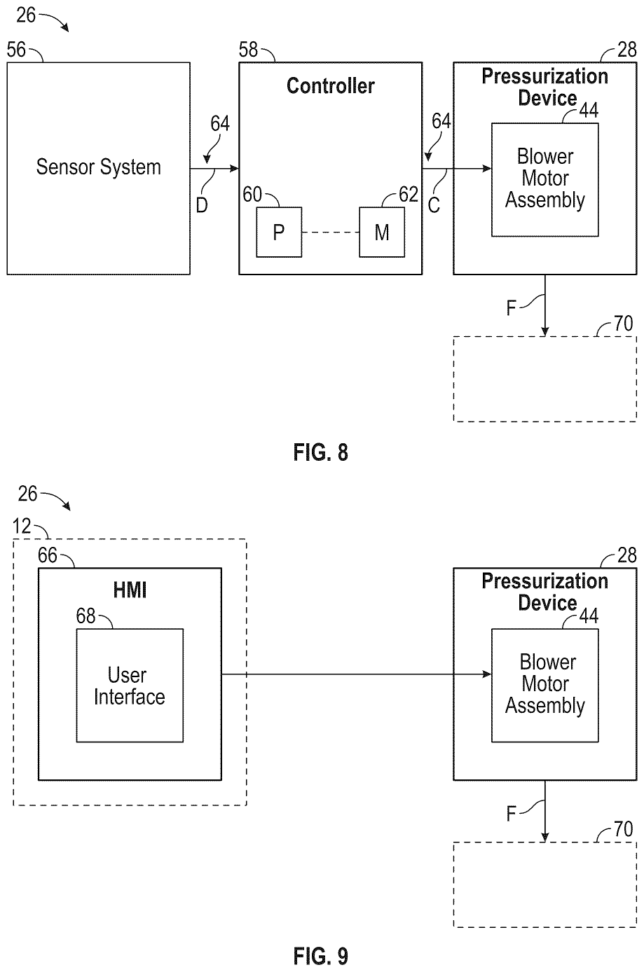

Referring now to FIG. 8, with continued reference to FIGS. 1-7, the positive pressurization system 26 may additionally include a sensor system 56 and a controller 58 that are operably connected to one another. The sensor system 56 may include a multitude of sensing devices arranged and configured for monitoring various vehicle conditions and/or environmental conditions. In an embodiment, the sensor system 56 includes a combination of both cameras and sensors that are positioned on and/or about the vehicle 10. The combination of cameras and sensors may include, for example, a rear facing camera (e.g., center high mounted stop lamp (CHMSL) camera), a particulate sensor, a wheel speed sensor, a carbon monoxide sensor, LIDAR sensors, etc. However, various other sensing devices could be included as part of the sensor system 56 of the positive pressurization system 26.

Although schematically illustrated as a single controller, the controller 58 may be part of a vehicle control system that includes a plurality of additional control modules for interfacing with and commanding operation of the various subcomponents of the positive pressurization system 26. In an embodiment, the controller 58 is part of a body control module (BCM) of the vehicle 10. However, other configurations are also contemplated within the scope of this disclosure.

The controller 58 may include both hardware and software and may be programmed with executable instructions for interfacing with and commanding operation of various components of the positive pressurization system 26 as part of a strategy for selectively pressurizing the enclosed cargo space 70 in order to substantially prevent environmental elements from entering therein.

The controller 58 may include a processor 60 and non-transitory memory 62 for executing various control strategies and modes associated with the positive pressurization system 26. The processor 60 may be a custom made or a commercially available processor, a central processing unit (CPU), or generally any device for executing software instructions. The memory 62 can include any one or combination of volatile memory elements and/or nonvolatile memory elements. The processor 60 may be operably coupled to the memory 62 and may be configured to execute one or more programs stored in the memory based on various inputs received from other devices associated with the positive pressurization system 26, such as inputs from the sensor system 56, for example.

Various subcomponents of the positive pressurization system 26 may be interconnected and in electronic communication with one another over one or more communication buses. For example, the blower motor assembly 44 of the pressurization device 28 and the sensor system 56 of the positive pressurization system 26 may each be operably connected to the controller 58 over a communication bus 64. In an embodiment, the communication bus 64 is a wired communication bus such as a controller area network (CAN) bus or a local interconnect network (LIN) bus, for example. In another embodiment, the communication bus 64 is a wireless communication bus such as that provided by Wi-Fi, Bluetooth®, Ultra-Wide Band (UWB), etc.

The sensor system 56 may periodically communicate sensor data D to the controller 58. The controller 58 may analyze the sensor data D received from the sensor system 56 for determining whether or not to activate the blower motor assembly 44 of the pressurization device 28. When the sensor data D indicates that activation is required/beneficial, the controller 58 may send a command signal C to the blower motor assembly 44 in order to activate the blower motor assembly 44 and thus begin directing the airflow F into the enclosed cargo space 70.

In an embodiment, the controller 58 may be programmed to activate/deactivate the blower motor assembly 44 based on various thresholds. For example, the controller 58 may send the command signal C to deactivate the blower motor assembly 44 when a vehicle speed threshold, a battery state of charge limit, a fuel limit, an engine limit, and/or a contamination threshold has been exceeded.

In another embodiment, the controller 58 may be programmed to confirm that the tailgate 20 of the vehicle 10 is in a closed position before activating the blower motor assembly 44. The controller 58 may command the tailgate 20 closed if there is nothing inhibiting its closure in order to establish the enclosed cargo space 70 and prepare it for pressurization.

In another embodiment, the controller 58 may be programmed to confirm that the cover 24 is installed and fully covering the cargo bed 14 before activating the blower motor assembly 44. If the cover 24 is not fully covering the cargo bed 14 and is an automatic cover, the controller 58 may command the cover 24 to a fully closed position. Alternatively, where the cover 24 is a manual system, the controller 58 may command that an alert be issued to the vehicle user, such as at a human machine interface located within the passenger cabin 12, for example.

In another embodiment, the controller 58 may be programmed to activate the blower motor assembly 44 when the sensor data D indicates that the vehicle 10 is traveling on a dirt road or a gravel road. This may be based, at least in part, on image recognition, machine learning, navigation information, etc. The controller 58 may further be programmed to vary an operating speed of the blower motor assembly 44 based on the amount of dirt/dust/debris detected at the location where the vehicle 10 is operating.

In another embodiment, the controller 58 may be programmed to activate the blower motor assembly 44 when the sensor data D indicates that a rough road index of the roadway the vehicle 10 is traveling upon exceeds a predefined rough road index threshold. The rough road index may be calculated continuously within the controller 58 by referencing pre-calibrated accelerometer and wheel speed data (e.g. recorded on control roads) and comparing that data to newly collected data as the vehicle 10 travels along any given roadway.

In another embodiment, the controller 58 may be programmed to activate the blower motor assembly 44 when the sensor data D indicates the presence of rain or snow.

In another embodiment, the controller 58 may be programmed to activate the blower motor assembly 44 when the sensor data D indicates that the traction control system of the vehicle 10 has been activated. An operating speed of the blower motor assembly 44 may be adjusted to be proportional to a current speed of the vehicle 10.

In another embodiment, the controller 58 may be programmed to activate the blower motor assembly 44 when the sensor data D indicates that dust particles are present within the cargo bed 14. The dust particles may be sensed by a particulate sensor of the sensor system 56 that is mounted within the enclosed cargo space 70, for example.

In another embodiment, the controller 58 may be programmed to activate the blower motor assembly 44 when the sensor data D indicates the presence of carbon monoxide within the covered cargo bed 14. The carbon monoxide level may be sensed by a gas sensor of the sensor system 56 that is mounted within the enclosed cargo space 70, for example.

In another embodiment, the controller 58 may be programmed to command operation of the blower motor assembly 44 at a predefined speed and for a predefined amount of time each time the vehicle 10 is turned on. Regular pressurization of the enclosed cargo space 70 in this manner can prevent the accumulation of debris therein.

In another embodiment, the controller 58 may be programmed to command operation of the blower motor assembly 44 in order to purge the enclosed cargo space 70 of dirt, dust, and/or debris each time the vehicle 10 is turned off. Regularly purging the enclosed cargo space 70 in this manner can help ensure that any air leakage gaps of the cargo bed 14 are clean prior to the vehicle 10 sitting idle.

In yet another embodiment, the controller 58 may be programmed to automatically activate/deactivate the blower motor assembly 44 when the vehicle 10 enters/exits a geofenced area. The geofenced area may either be learned or manually selected by the vehicle user.

The above control strategies for controlling the blower motor assembly 44 of the pressurization device 28 in order to induce pressurization of the enclosed cargo space 70 are exemplary only. The positive pressurization system 26 could be controlled in various other ways to prevent environmental elements from entering into the enclosed cargo space 70.

Referring now to FIG. 9, with continued reference to FIGS. 1-8, the positive pressurization system 26 may also be capable of manual activation. For example, the positive pressurization system 26 may include a human machine interface (HMI) 66 located within the passenger cabin 12 of the vehicle 10. The HMI 66 may include various user interfaces for displaying information to the vehicle occupants and for allowing the vehicle occupants to enter information into the HMI 66. The vehicle occupants may interact with the user interfaces via touch screens, tactile buttons, audible speech, speech synthesis, gesture recognition, etc. In an embodiment, the HMI 66 is part of an in-dash infotainment system of the vehicle 10. However, other configurations are further contemplated within the scope of this disclosure.

The HMI 66 may include one or more user interfaces 68 specifically dedicated to functionality associated with the positive pressurization system 26. The one or more user interfaces 68 may allow the user to manually command activation/deactivation of the blower motor assembly 44 of the pressurization device 28 for delivering the airflow F to the enclosed cargo space 70. For example, the user may desire to manually activate the positive pressurization system 26 prior to or while operating the vehicle 10 on a dirt or gravel road, when passing through a construction zone, for drying any moisture that has accumulated within the enclosed cargo space 70, for selecting a purge cycle for purging the enclosed cargo space 70, etc.

The positive pressurization systems of this disclosure are capable of pulling air from a location exterior to an enclosed cargo space, filtering the air, and then using the air to pressurize the enclosed cargo space. The pressurization is sufficient to substantially prevent contaminant entry, and, advantageously, can be provided completely independently of the vehicle's dedicated passenger cabin heating, cooling, and ventilation (HVAC) system.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A motor vehicle, comprising:
an enclosed cargo space; and
a pressurization device including a blower motor assembly operable to direct an airflow into the enclosed cargo space for pressurizing the enclosed cargo space.

2. The motor vehicle as recited in claim 1, wherein the enclosed cargo space is established by a cargo bed and a cover that is securable to the cargo bed.

3. The motor vehicle as recited in claim 2, wherein the pressurization device is mounted within a bedside cavity of a side wall of the cargo bed.

4. The motor vehicle as recited in claim 3, wherein the bedside cavity extends between an inner panel and an outer panel of the side wall.

5. The motor vehicle as recited in claim 4, wherein an outlet port of the pressurization device is positioned within the inner panel for directing the airflow into the enclosed cargo space.

6. The motor vehicle as recited in claim 3, wherein the pressurization device is mounted at a location between a wheel well and a front wall of the cargo bed.

7. The motor vehicle as recited in claim 1, wherein the blower motor assembly is housed within a first portion of a housing of the pressurization device, an intake duct extends in a first direction from the first portion of the housing, and an exhaust duct extends in a second direction from the first portion of the housing.

8. The motor vehicle as recited in claim 7, wherein an inlet port of the pressurization device is connected to the intake duct, and an outlet port of the pressurization device is connected to the exhaust duct.

9. The motor vehicle as recited in claim 7, wherein the pressurization device includes an air filter that is positioned within the intake duct.

10. The motor vehicle as recited in claim 9, wherein the blower motor assembly is operable to pull an intake air from atmosphere through the air filter prior to directing the airflow into the enclosed cargo space.

11. The motor vehicle as recited in claim 1, comprising a sensor system configured to sense a condition internal or external to the enclosed cargo space.

12. The motor vehicle as recited in claim 11, comprising a controller programmed to command activation or deactivation of the blower motor assembly based on sensor data received from the sensor system.

13. A positive pressurization system for a motor vehicle, comprising:
a pressurization device including a blower motor assembly;
a sensor system operable to sense a condition in or around the motor vehicle; and
a controller programmed to command activation or deactivation of the blower motor assembly based on sensor data received from the sensor system.

14. The positive pressurization system as recited in claim 13, wherein the blower motor assembly is operable to provide an airflow for pressurizing an enclosed cargo space of the motor vehicle when activated.

15. The positive pressurization system as recited in claim 13, wherein the controller is programmed to activate the blower motor assembly when the sensor data indicates that the motor vehicle is traveling on a dirt road or a gravel road.

16. The positive pressurization system as recited in claim 13, wherein the controller is programmed to activate the blower motor assembly when the sensor data indicates a presence of dust particles within an enclosed cargo space of the motor vehicle.

17. The positive pressurization system as recited in claim 13, wherein the controller is programmed to activate the blower motor assembly when the sensor data indicates a presence of rain or snow.

18. The positive pressurization system as recited in claim 13, wherein the controller is programmed to activate the blower motor assembly when the sensor data indicates a presence of carbon monoxide.

19. The positive pressurization system as recited in claim 13, wherein the controller is programmed to activate the blower motor assembly when a wheel speed threshold has been exceeded.

20. The positive pressurization system as recited in claim 13, wherein the controller is programmed to activate the blower motor assembly when the motor vehicle enters a geofenced area.
